(19) United States
(12) Patent Application Publication
(10) Pub. No.: US 2006/0064394 A1
(43) Pub. Date: Mar. 23, 2006

(54) Method for handling changing and disappearing online references to research information

(75) Inventors: Richard D. Dettinger, Rochester, MN (US); Frederick A. Kulack, Rochester, MN (US)

Correspondence Address: William J. McGinnis;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/944,621

(22) Filed: Sep. 17, 2004

(51) Int. Cl. G06F 17/24; G06F 17/30

(52) U.S. Cl. 707/1; 715/501.1; 707/200; 715/512

(57) ABSTRACT

A method, system, and computer-readable medium for preserving an association between electronic documents are provided. In one embodiment of the invention, an electronic document is stored at a storage media address, the electronic document containing a citation, the citation containing a link to a network address of a remotely located electronic document. A copy of the remotely located electronic document is stored, and the electronic document is associated with the copy. A request is received for the remotely located electronic document, and an attempt to access the remotely located electronic document is made. If the remotely located electronic document cannot be accessed, a copy of the remotely located electronic document is returned.

### BACKGROUND OF THE INVENTION

1. Field of the Invention

The present invention generally relates to a method of preserving associations between electronic documents.

2. Description of the Related Art

The growth of the Internet has revolutionized information access. Using Internet search engines, a vast number of remotely located electronic documents containing vast amounts of information may be quickly accessed with little or no effort. Because the Internet contains such vast amounts of information that may be searched quickly and efficiently, researchers and academics are using the Internet more and more to conduct their research. Research results, which may be presented in an electronic research document, may contain citations to the documents which were used by the researcher. These citations may be used by readers of the research document to verify the accuracy of the results presented in a research document, or to gain more information about the subject to which the citation pertains.

The citations to documents in the electronic research document may themselves be electronic documents accessible through a network such as the Internet, However, while the Internet (and networks generally) provide a convenient means of storing and accessing electronic documents, the Internet is a very fluid and changing environment. Remotely located electronic documents may be moved from one location on a web site to another or taken down, the server storing an electronic document may change addresses or crash, and the company or entity providing the electronic document may go out of business or close the web site containing the electronic document. Each situation may cause a temporary or permanent loss of the information being cited in a research document. Loss of the information cited in a research document may present a problem for the researcher, whose research may be harmed when persons reviewing the research document cannot find the sources being cited, and thus cannot verify the correctness of the research. This places a greater burden on the researcher to avoid citing remotely located electronic documents because, while the documents may provide valuable information that is easily accessible, the documents are transitory and may not remain accessible for long.

In addition to becoming unavailable, remotely located documents may be changed or updated by the author or administrator of the remote document. A researcher may create a research document which contains reasoning and conclusions drawn from a cited document. If the cited document is changed or updated, the reasoning and conclusions drawn from that document may become incorrect without the researcher's knowledge. Additionally, persons reading the research document, upon referring to the changed remote document, may think that the researcher has mischaracterized the cited document or drawn incorrect conclusions from the cited document, reflecting negatively upon both the research and the researcher.

Ultimately, the researcher would prefer that persons viewing the electronic research document (including the researcher herself) have a persistent copy of remote electronic documents being cited available to them. It would also be preferable that the researcher and other persons viewing the electronic research document be informed of any changes in a cited document that have occurred since the citation was made. Currently, researchers and viewers of research documents do not have any tools which provide this functionality. Accordingly, what is needed is a method for ensuring that a remotely located document cited in an electronic research document is available to a viewer of the electronic research document and that the cited document has not changed since the citation of that document took place.

### SUMMARY OF THE INVENTION

The present invention generally provides a method, a system, and a computer-readable medium for preserving an association between electronic documents. One embodiment provides for storing an electronic document at a storage media address, the electronic document containing a citation, the citation containing a link to a network address of a remotely located electronic document, storing a copy of the remotely located electronic document, associating the electronic document and the copy, receiving a request for the remotely located electronic document, attempting to access the remotely located electronic document, and if the remotely located electronic document cannot be accessed, returning the copy of the remotely located electronic document.

Another embodiment provides a system comprising a processor, a network connection device, and a storage media. The storage media contains a copy of an electronic document remotely located at a network address, a local electronic document which contains a pointer to the remotely located electronic document, the copy being associated with the local electronic document, and a program. The program, when executed by the processor, performs the steps comprising receiving a request for the remotely located electronic document, determining whether the remotely located electronic document is unavailable or changed by querying the remotely located electronic document across the network connection device, if the remotely located document is unavailable, returning the copy of the remotely located electronic document, and if the remotely located electronic document is changed, displaying a change notification.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a diagram illustrating an exemplary networked environment configured for use with the present invention.

FIG. 2 is a diagram illustrating a storage format for creating an association between an electronic document and copies of remotely located electronic documents according to one embodiment of the invention.

FIG. 3 is a diagram illustrating a storage format for creating an association between an electronic document and copies of remotely located electronic documents according to another embodiment of the invention.

FIG. 4 is a flow diagram illustrating a process for caching cited documents according to one embodiment of the invention.

FIG. 5 is a flow diagram illustrating a process for displaying changes to cited documents according to one embodiment of the invention.

FIG. 6 is a flow diagram illustrating a process for saving hashcodes for a cited document according to one embodiment of the invention.

FIG. 7 is a flow diagram illustrating a process for displaying change notifications for cited documents using hashcodes according to one embodiment of the invention.

FIG. 8 is a flow diagram illustrating a process for displaying a credibility score for a cited document according to one embodiment of the invention.

FIG. 9 is a diagram illustrating a graphical user interface for displaying a research document containing a citation according to one embodiment of the invention.

FIG. 10 is a diagram illustrating a graphical user interface for accessing and comparing an original and cached version of a remote document according to one embodiment of the invention.

### DETAILED DESCRIPTION OF THE PREFERRED EMBODIMENTS

The present invention generally relates to a method, computer-readable medium, and system for preserving an association between electronic documents. One embodiment includes storing an electronic document at a storage media address, the electronic document containing a citation, the citation containing a link to a network address of a remotely located electronic document, storing a copy of the remotely located electronic document, associating the electronic document and the copy, receiving a request for the remotely located electronic document, attempting to access the remotely located electronic document, and if the remotely located electronic document cannot be accessed, returning the copy of the remotely located electronic document.

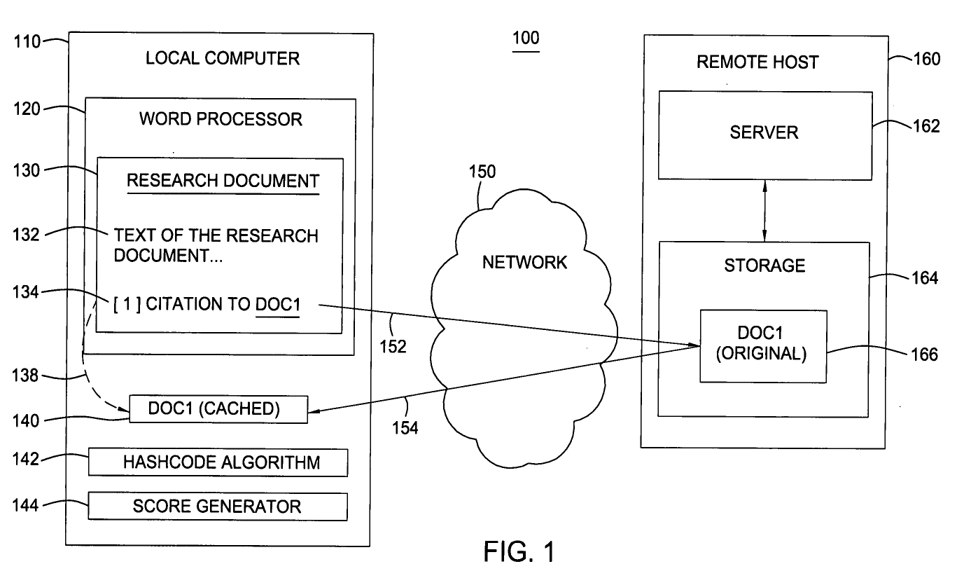

One embodiment of the invention is implemented as a program product for use with a computer system such as, for example, the network environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Further, in the following, reference is made to embodiments of the invention. The invention is not, however, limited to specific described embodiments. Instead, any combination of the following features and elements, whether related to different embodiments or not, is contemplated to implement and practice the invention. Furthermore, in various embodiments the invention provides numerous advantages over the prior art. Although embodiments of the invention may achieve advantages over other possible solutions or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in the claims. Similarly, reference to “the invention” shall not be construed as a generalization of any inventive subject matter disclosed herein and shall not be considered to be an element or limitation of the appended claims, except where explicitly recited in a specific claim.

The networked environment 100 shown in FIG. 1 may contain a local computer 110 capable of accessing a remote host 160 across a network 150. According to one embodiment of the invention, the local computer 110 may contain a word processor program 120 which may implement some of the functionality of the present invention, though other programs may be used to implement the functionality such as an internet browser, a document viewer, or any program capable of displaying or editing documents known to those skilled in the art. The word processor 120 may be used to create and edit a research document 130 (also referred to herein as an electronic document). The research document 130 may be stored in any format, such as Microsoft Word format, hypertext markup language (HTML) format, extensible markup language (XML) format, or any similar format for displaying documents known to those skilled in the art. The research document 130 may be stored at a storage media address. This address may include an absolute memory address, a file name and file path, or any other address used for storing data in a computer system. Also, while embodiments of the invention are described with respect to a research document, the present invention may be used with any electronic document (about topics other than research) which cites to, links to, or refers to an electronic document stored at a network address. The local computer may also contain a hashcode algorithm 142 for generating hashcodes and a score generator 144 for generating scores, the use of which described below in detail.

According to one embodiment of the present invention, the research document 130 may contain text 132 along with a citation (also referred to as a reference) 134 to a remotely located document 166 (also referred to as a source, or reference). The citation 134 may be in any format used by researchers, including a textual citation, a footnote, or an endnote. The citation 134 may also be contained in a bibliography, list of sources, appendix, or any other listing that researchers use to list citations. Finally, the citation 134 may list the cited remotely located document 166 by the name of the document, by a location of the document such as a network address, by a description of the document, or by any method employed by researchers to cite documents.

In one embodiment of the invention, the research document 130 may also contain a link 136 to the remotely located document 166. The link 136 may contain the network address of the remotely located document 166. The network address of the remotely located document 166 may be in the form of a Uniform Resource Locator (URL), a Uniform Resource Identifier (URI), a Uniform Resource Name (URN), an internet protocol (IP) address, a domain name, pathname and filename, or any other form of network address known to those skilled in the art. As described in further detail below, the word processor 120 may use the network address to send a request 152 across the network 150 to the remote host 160 regarding the remotely located document 166. The remote host 160 may contain storage 164 for storing the document 166 and a server 162 for processing document requests. The server 162, upon receiving a request 152 for the document 166, may retrieve the document 166 from storage 164 and send a response 154 containing the document 166 across the network 150 to the local computer 110. The local computer 110, after retrieving the response 154 may store a local copy 140 of the document 166 at a storage media address. The process of retrieving a local copy 140 of the remote document 166 may also be referred to as downloading, copying, caching, or accessing.

The present invention allows an association 138 to be created between the research document 130 and the copy 140 of the remotely located document 166 which is being cited. Thus, if the cited document 166 is moved, replaced, or modified, or if the remote host 160 is moved or taken down, the copy 140 of the original document 166 may still be accessed using the association 138 between the research document 130 and the local copy 140.

The association 138 between the local copy 140 of the document 166 and the research document 130 may be created in several ways according to different embodiments of the invention. The association 138 may be created by adding a link to the research document 130 containing the storage media address of the local copy 140. This link may point to a location in memory at which the copy 140 is stored, or the link may provide a file name and file path for the copy 140, or any storage media address used for storing documents. The association 138 may also be created by placing the copy 140 of the document 166 in the same file directory as the research document 130, in a special file directory recognized by the research document 130 or the word processor 130, or in any designated file directory. Another way of creating the association 138 may be to place the research document 130 and the local copy 140 in a unitary storage file. The unitary file, which may be referred to as a document archive, may be stored in a file format such as a zip file, a jar file, a tar file, a cabinet file (.cab) or any other file format used to store multiple files.

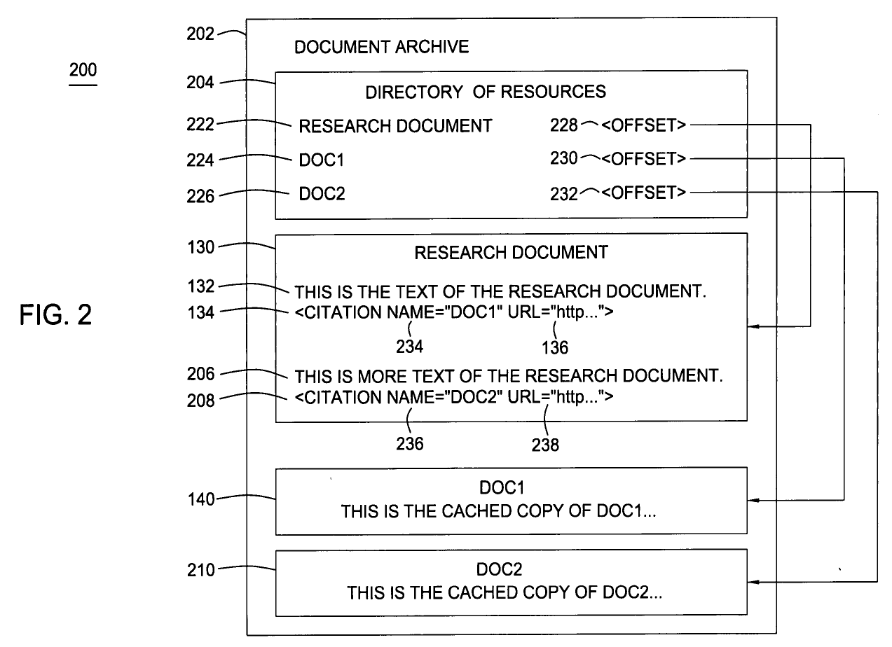

FIG. 2 is a diagram illustrating a first storage format 200 for creating an association 138 between an electronic document 130 and a copy 140 of a remotely located electronic document 166. Each document may be contained in a document archive 202. The document archive 202 may contain a directory of resources 204, the research document 130, a local copy 140 of a first cited document 166 and cached versions 210 of other documents. The research document may contain a first block of text 132 containing a first citation 134. The citation 134 may contain a name 234 of the remotely located document 166 being cited and a network address 136 for the remotely located document 166 being cited. The research document 130 may also contain other text 206 with citations 208, and each other citation 208 may contain a document name 236 and a network address 238 for the remotely located document 166 being cited.

For each document 130, 140, 210 stored in the document archive 202, the directory of resources 204 may contain the names 222, 224, 226 of the documents and a respective offset 228, 230, 232 specifying where in the document archive 202 each document may be found. If a user requests the document 166 associated with the first citation 134, the word processor 130 or other program may determine that the remote document is unavailable (described below in greater detail). If the remotely located document 166 is unavailable, the word processor 130 or other program may provide the user with the local copy 140 of the remotely located document 166 by taking the name 234 in the citation 134, finding the corresponding name 224 in the directory of resources 204, finding the offset 230 associated with the name 224, and using the offset 230 to locate the local copy 140 of the remote document 166. Thus, if the remote document 166 is unavailable, as long as the user has a copy of the document archive 202 containing the research document 130, the user will have access to the local copy 140 of the resource 166 being cited 134.

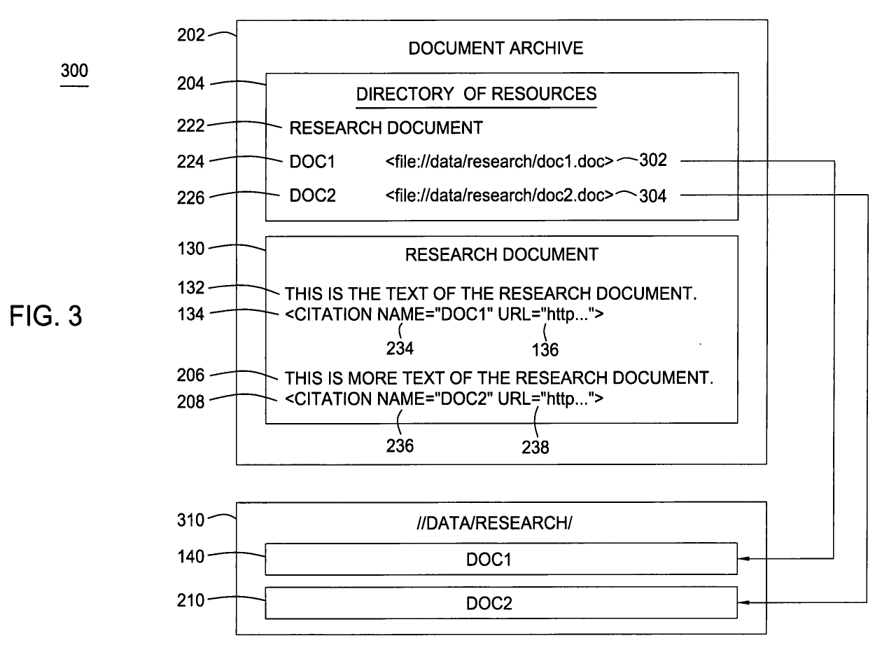

FIG. 3 is a diagram illustrating a second storage format 300 for creating an association 138 between an electronic document 130 and the copy 140 of a remotely located electronic document 166. The research document 130 may be contained in a document archive 202. The document archive 202 may contain a directory of resources 204. The research document may contain a first block of text 132 containing a first citation 134. The citation 134 may contain a name 234 of the document being cited 166 and a network address 136 for the document being cited 166. The research document 130 may also contain other text 206 with citations 208, and each other citation 208 may contain a document name 236 and a network address 238 for the document being cited.

For each document cited in the research document 130, the directory of resources 204 may contain the name of the document 224, 226 and a file path 302, 304 specifying a folder 310 where each document 140, 210 may be found. Because the document archive 202 may contain the research document 130, the directory of resources 204 may contain the name 222 for the research document 130 but may not have a file location. If a user requests the document 166 cited by the first citation 134, the word processor 130 or other program may determine that the remote document is unavailable. If the remotely located document 166 is unavailable, the word processor 130 or other program may provide the user with the local copy 140 of the remotely located document 166 by taking the name in the citation 234, finding the corresponding name 224 in the directory of resources, finding the file path 302 associated with the name 224, and using the file path 302 to locate the local copy 140 in a folder 310 in the file system. Thus, if the remote document 166 is unavailable, as long as the user has a copy of the research document 130 contained in the document archive 202, and as long as the local copy 140 remains in the local folder 310, the user will have access to the local copy 140 of the resource 166 being cited 134.

According to another embodiment of the present invention, the storage format of the research document 130 and the local copies may take into account the possible copyright of the underlying cited documents. For instance, the user may be presented with an “Encrypted Save” option which allows the user to encrypt the local copy 140 of the remotely located document 166. The local copy 140 may then be encrypted and a decryption key may be stored in a metadata tag within the header of the research document 130. Whenever the check is made to determine if the cited document 166 has changed (as described below in greater detail), the local copy 140 may be decrypted and compared to the remotely located document 166. Thus, the user may be informed of any changes which have occurred to the remotely located document 166. Optionally, a copy of the decryption key may be provided only to certain privileged users, such as the author or an editor of the research document 130. Thus, certain users may be granted access to the local copies of the cited documents while others may be denied access.

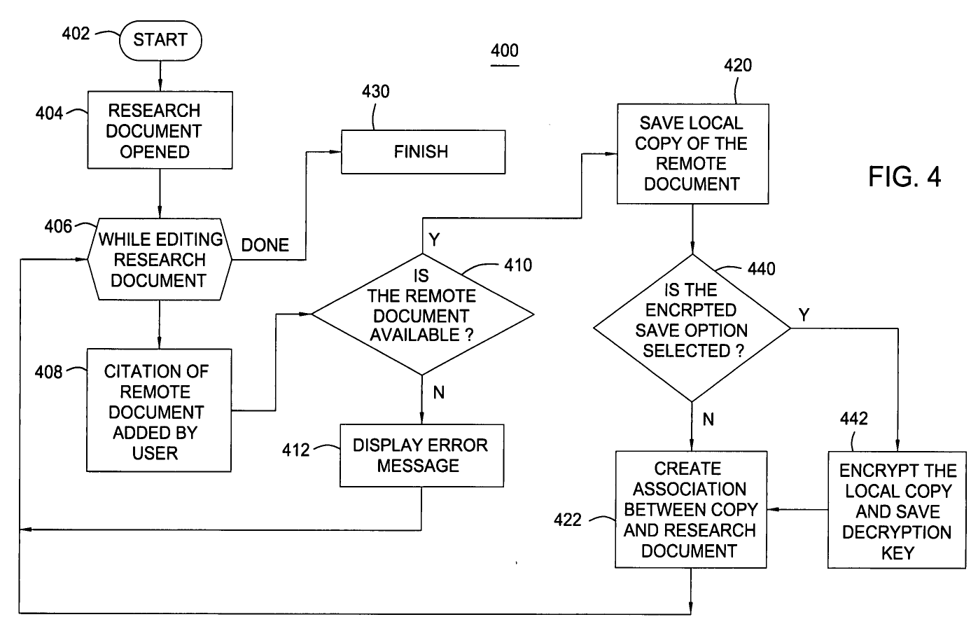

FIG. 4 is a flow diagram illustrating a process 400 for caching cited documents according to one embodiment of the invention. The process 400 begins at step 402 and continues to step 404 where the research document 130 is opened. The process enters a loop at step 406 that continues while the research document 130 is being edited. At step 408, the citation 134 of the remote document 166 may be added by the user.

The citation 134 may be added by the user in several ways according to separate embodiments of the invention. According to one embodiment of the invention, the user may highlight the portion of text 134 that the user wishes to substantiate. The user may then select an option from a contextual pop-up menu or pull-down menu which allows the user to add the citation 134 as a footnote, an endnote, or in a bibliography or appendix. When the user adds the citation 134, the user may also be prompted for a network address for the remotely located document 166. The network address provided by the user may be used to automatically create the link 136 within the document 130. The user may also add the citation 134 by manually typing in the citation 134 and adding the link 136. The user may add the link 136 by selecting the text which will serve as the link 136 and then using a contextual pop-up menu or a pull-down menu to select a “Hyperlink . . . ” option, such as the option provided by the Microsoft Word program. Upon selecting the “Hyperlink . . . ” option, the user may be presented with a dialog box which allows the user to type in the network address for the remotely located document 166 and create a link for the selected text.

When the citation of the remote document 166 is added at step 408, the process 400 may determine whether the remote document 166 is available at step 410. The process 400 may determine whether the remote document 166 is available by sending a request 152 to the network address provided by the user. If the remote document 166 is available, the server 162 on the remote host 160 may return a response 154 containing the remote document 166. If the remote document 166 is unavailable, the server 162 on the remote host 160 may return a response 154 containing an error message. The error message may contain a statement that the file was not found, a statement that the server is down, or a statement that the file has been moved. If the user enters an improper network address for the remote document 166, or if the remote document 166 is unavailable for any reason, the process may display the error message to the user at step 412. If, however, the remote document 166 is available, the remote document 166 may be saved as a local copy 140 at step 420. At step 440 a determination may be made of whether the user has selected an “Encrypted Save” option for each locally saved document. If the “Encrypted Save” option has not been selected, an association between the local copy 140 and the research document 130 may be created at step 422. If, however, the “Encrypted Save” option is selected, the local copy 140 may be encrypted and the decryption key may be saved at step 442. The manner in which the decryption key is saved may vary according to different embodiments of the invention. The decryption key may be stored in a special folder, in a file header for the research document 130, as metadata within the link 136 to the remote document 166, or in any manner known to those skilled in the art. After the local copy 140 has been encrypted and the decryption key has been saved, the local copy 140 may be associated with the research document 130 at step 422. The research document 130 may continue to be edited in the loop started at step 406 until the process finishes at step 430.

It should be noted that FIG. 4 describes merely one embodiment of the present invention. The local copy 140 of the remote document 166 may be saved in a different manner according to other embodiments of the invention. According to one embodiment of the present invention, the user may be provided with drop down menus or contextual pop-up menus containing options which allow the user to select the link 136, automatically request 152 the remote document 166, download the response 154, save the local copy 140, and create the association 138 between the research document 130 and the local copy 140. The local copy 140 of the remote document may also be saved when the user selects the link 136 and views the remote document 166.

According to one embodiment of the invention, the citation 134 may also be automatically detected as it is typed by the user and a request 152 for the document 166 may be sent automatically. The response 154 containing the document 166 may then be automatically downloaded and stored as the local copy 140, and the association 138 between the research document 130 and the cached document 140 may be created automatically. The user may also be presented with a menu option to scan the entire research document 130, detect every citation (such as the citation 134) in the document 130, automatically send requests download responses for each remotely located document, save a local copy of each cited document, and create the associations between the local copies and the electronic research document 130 accordingly. According to another embodiment of the invention, the user may manually create the association. The user may download a local copy 140 of the remote document 166. The user may then select a menu option which allows the user to enter the storage media address of the local copy 140. Upon entering the storage media address of the local copy 140, the association 138 between the research document 130 and the local copy 140 may be automatically created.

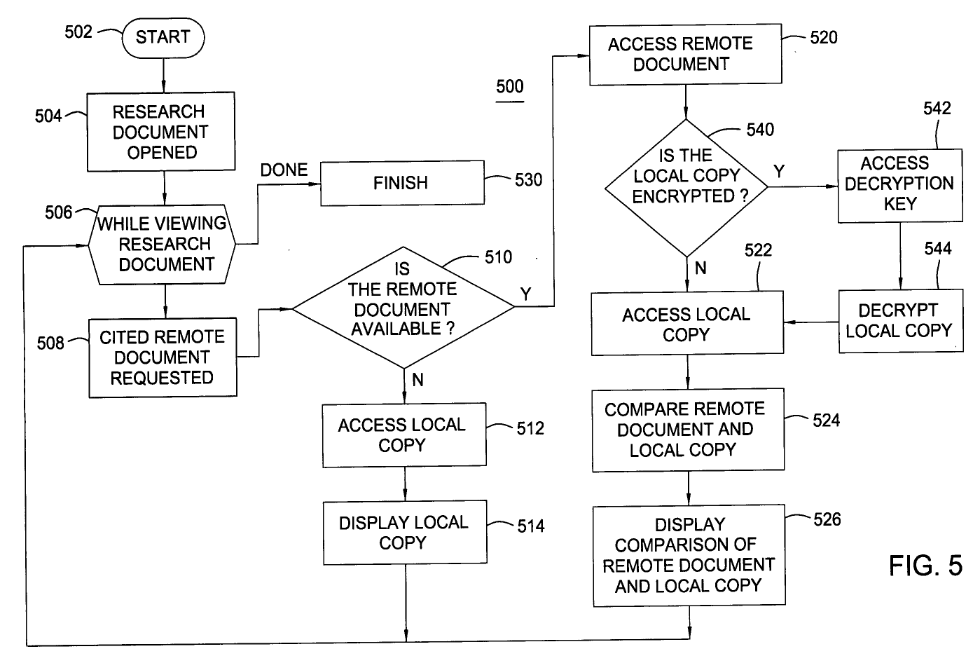

FIG. 5 is a flow diagram illustrating a process 500 for displaying changes to cited documents according to one embodiment of the invention. The process 500, which may run concurrently with process 400, may begin at step 502 and continue to step 504 where the research document 130 is opened. The process 500 may enter a loop at step 506 which continues while the research document 130 is being viewed. When a cited remote document 166 is requested at step 508, the process may determine whether the remote document 166 is available (as described above) at step 510. If the remote document 166 is not available, the local copy 140 of the document 166 may be accessed at step 512 and may be displayed to the user at step 514. If, however, the remote document 166 is available, the remote document 166 may be accessed at step 520. At step 540, a determination may be made of whether the local copy 140 is encrypted. If the local copy 140 is not encrypted, the local copy 140 may be accessed at step 522. If, however, the local copy is encrypted, the decryption key may be accessed at step 542, at step 544 the local copy 140 may be decrypted, and at step 522 the local copy 140 may then be accessed. The process 500 may then continue to step 524 where the local copy 140 and the remote document 166 may be compared. At step 526 a comparison of the local copy 140 and the remote document 166 may be displayed. The document may then continue to be viewed in the loop started at step 506 until the process finishes at step 530.

Download and comparison of the online document 166 and the cached version 140 may also be performed at times other than when a user has requested the cited document 166. For instance, within the word processor 120, a programmer may specify an event and cause the comparison to be performed based upon the occurrence of that event. In the embodiment of the invention depicted in FIG. 5, the event is a user request for the cited document 166.

The event may also be specified as the opening of the document according to another embodiment of the invention. Thus, when the document is opened, each cited document, such as the cited document 166, may be downloaded 154 and compared to the cached version 140 and a report of any changes which have been made to the cited documents may be presented to the user. More changes in the cited documents may imply that the research document 130 should not be relied on as a source whereas fewer changes may imply that the research document may be relied on as valid authority. Thus, by viewing a report reflecting the changes which have occurred within the cited documents, the author of the research document 130 may be informed of the extent to which the content of the research document is no longer valid. By viewing the same report, a user may judge the quality of the research contained in the research document 130 as well as the extent to which the reasoning of the research document 130 may be relied on. As previously mentioned, the author/user may also be provided with an option to view a comparison of each of the originally cited documents and the changed versions of the documents.

The event which causes a comparison to be performed may also be set to occur periodically. In one embodiment, this may be implemented by a software timer or a hardware timer which periodically causes the word processor 120 to download the cited document 166 and compare the online version 166 to the cached version 140. The word processor 120 may contain an option which allows the user to decide how often the download and comparison are performed. Thus, a researcher that desires to stay up to date with respect to a certain citation 134 may request frequent comparisons of the online 166 and cached versions 140. If, however, the researcher knows that the cited document 166 does not change often, the researcher may set the timer to go off less frequently, and thus the comparison may not be performed as often.

In addition to comparing the current version of the remotely located document 166 with the local copy 140, a credibility score may be calculated. The credibility score may be displayed to the user to inform the user how much the current version of the remotely located document 166 differs from the local copy 140. According to one embodiment of the invention, the credibility score may be large to reflect more credibility, or optionally, the credibility score may be small to reflect more credibility. The credibility score may be generated by a program such as the score generator 144 depicted in FIG. 1. According to other embodiments of the invention, the score may be generated by another program such as the word processor program 130, by a combination of programs, or using any method known to those skilled in the art.

According to one embodiment of the invention, the credibility score may be calculated by adding the number of words deleted from the remotely located document 166 to the number of words added to the remotely located document 166. Thus, if there are many changes, the credibility score may be high, and if there are no changes, the credibility score may be zero. The credibility score may also be weighted according to the changes made to the remotely located document 166. For instance, changes to the title may be weighted less than changes to substantive portions of the remotely located document 166. Alternatively, small typos or mere changes to the appearance of the remotely located document 166 may be given no weight in calculating the credibility score. Additionally, more complicated analysis may be performed using statistical analysis to measure the changes to the remotely located document, The credibility score may also be calculated in any other way known to those skilled in the art.

According to another embodiment of the invention, the remotely located document 166 may not be downloaded and saved as a local copy 140. However, the determination of whether the remotely located document has changed may still be performed. The determination of whether the remotely located document has changed may be performed without a local copy 140 by using a hashcode generated from the original document. A hashcode is a number or alphanumeric string which may be used to represent a document. The hashcode for a document may not contain any information about the contents of the document. Thus, hashcodes may be used in lieu of a local copy 140 and in lieu of an encrypted local copy to entirely avoid any problems associated with the violation of any copyrights on the remotely located electronic documents being cited.

The hashcode may be generated using any computer algorithm for generating hashcodes known to those skilled in the art, such as the hashcode algorithm 142 depicted in FIG. 1. Each hashcode may be created by running the hashcode algorithm 142 using the document being cited as input to the hashcode algorithm 142. The hashcode algorithm 142 may be implemented as a standalone computer program, as a part of the word processor 120, or using a series of programs or programming libraries. If the remotely located document 166 is modified, the hashcode generated by the hashcode algorithm 142 is also modified. Thus, comparing a hashcode generated for a document at one point in time to a hashcode generated for the document at another point in time may be used to determine if the document is changed. If the hashcodes are the same, the document is presumed not to have changed. If the hashcodes are different, the document is presumed to have changed.

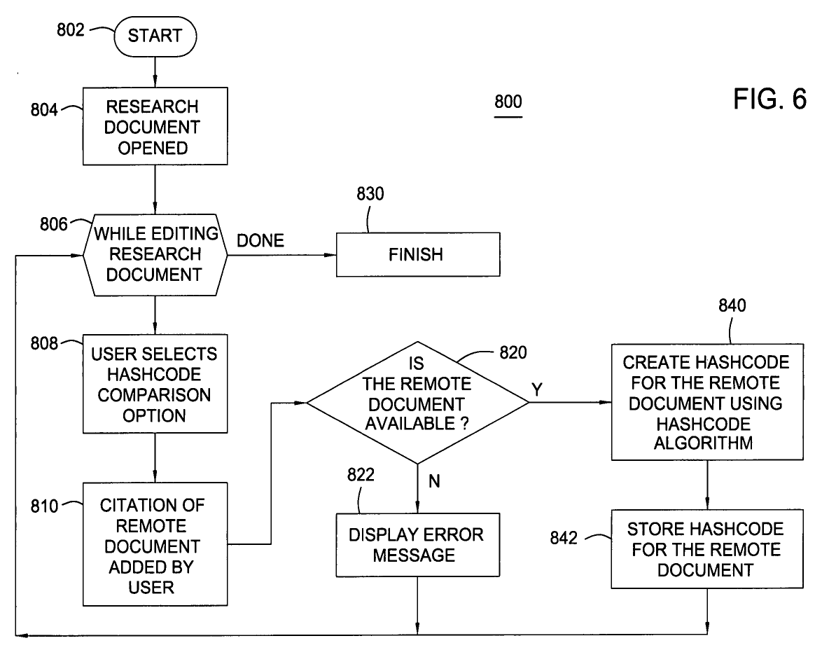

FIG. 6 is a flow diagram illustrating a process 800 for saving hashcodes for a cited document according to one embodiment of the invention. The process 800 may begin at step 802 and continue to step 804 where the research document 130 is opened. The process 800 may then enter a loop at step 806 which may continue while the research document 130 is being edited. At step 808 the user may select an option which causes the comparison of the current version of the remote document 166 and the old version of the remote document 166 to be implemented using hashcodes. When a citation 134 to the remote document 166 is added at step 810, a determination may be made at step 820 of whether the remote document 166 is available. If the remote document 166 is not available, an error message may be displayed at step 822. If, however, the remote document 166 is available, a hashcode for the remote document 166 may be created at step 840 using any hashcode algorithm known to those skilled in the art, such as the hashcode algorithm 142. At step 842, the hashcode for the remote document 166 may be stored. The hashcode generated by the hashcode algorithm 142 may be stored in a header file of the research document 130 according to one embodiment of the invention. However, the hashcode may also be stored as metadata within a link to the remote document 166 or in any other form known to those skilled in the art. After the hashcode has been stored at step 842, the loop which began at step 806 may continue until the process 800 finishes at step 830.

Because the entire remote document 166 may not be saved as a local copy 140 when the hashcode is saved, the exact changes which may have been made to the remote document 166 may not be known. Where the remote document 166 is not saved as a local copy 140, if the hashcodes for the current version and old version of the remote document 166 are used to determine that the remote document 166 has changed, a change notification may still be displayed to the user, allowing the user to view the remote document 166 and ascertain if any substantive changes have been made.

According to another embodiment of the invention, hashcodes may be used to calculate the credibility score for the remote document 166 even when the remote document 166 is not saved as a local copy 140. The credibility score may be calculated by saving a hashcode for some subdivision (such as a paragraph, a sentence, a section, or some other subdivision) of the remotely located document 166. When a credibility score is requested, the remotely located document 166 may be accessed and a new set of hashcodes may be created for each subdivision of the remotely located document 166. The new set of hashcodes may be compared to the old set of hashcodes for each subdivision. If the corresponding hashcodes have changed, then the subdivision may have changed. Thus, the credibility score may be calculated according to the number of changes that have occurred on a per subdivision basis. Thus, while the exact changes to the remote document 166 may remain unknown, the credibility score may still give the user an estimation of how much the underlying document has changed.

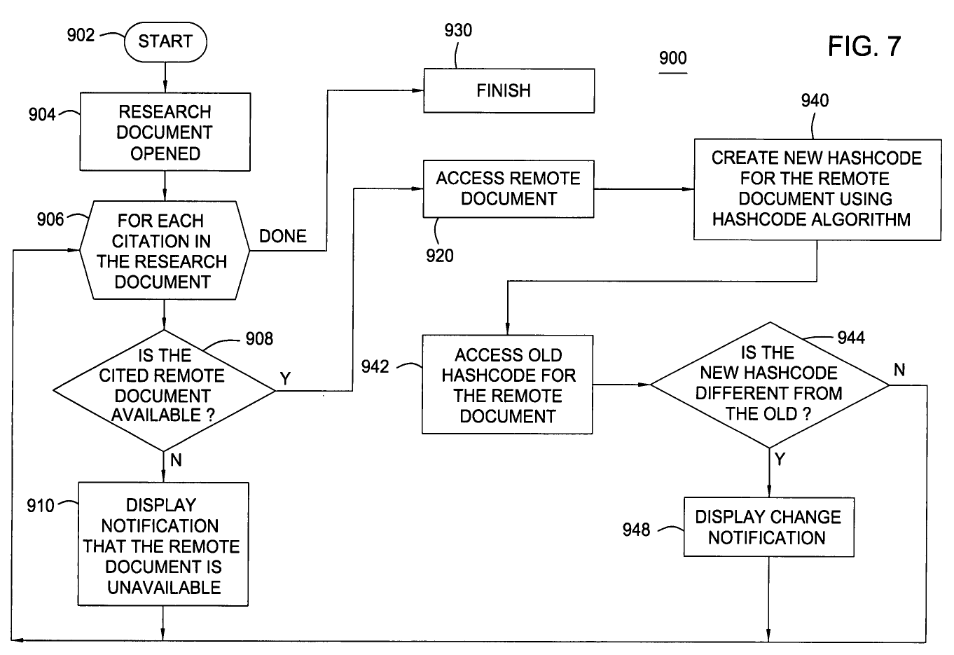

FIG. 7 is a flow diagram illustrating a process 900 for displaying change notifications for cited documents using hashcodes according to one embodiment of the invention. The process 900 may begin at step 902 and continue to step 904 where the research document 130 is opened. According to one embodiment of the invention (as described above), opening the research document 166 at step 904 may cause the entire group of cited documents within the research document 130 to be examined for changes. Thus, at step 906, the process 900 may enter a loop that continues for each citation in the research document 130. At step 908 a determination may be made of whether the remote document 166 is available. If the remote document 166 is unavailable, a notification may be displayed at step 910 which informs the user that the remote document 166 is unavailable. If, however, the remote document 166 is available, the remote document 166 may be accessed at step 920 and a new hashcode for the current version of the remote document 166 may be created at step 940. At step 942 the old hashcode for the previous version of the remote document may be accessed and at step 944 a determination may be made of whether the new hashcode is different from the old hashcode. If the new hashcode is not different from the old hashcode, the loop beginning at step 906 may continue. If, however, the new hashcode is different from the old hashcode a change notification may be displayed to the user at step 948 which may inform the user that the remote document 166 has changed. After each citation has been examined in the loop beginning at step 906, the process may finish examining the citations at step 930. While the process 900 is described with reference to a change notification being generated using a single hashcode, according to other embodiments of the invention the process 900 may be modified to generate the change notification as well as a credibility score using multiple hashcodes for each subdivision of the remotely located document 166, as described above in greater detail.

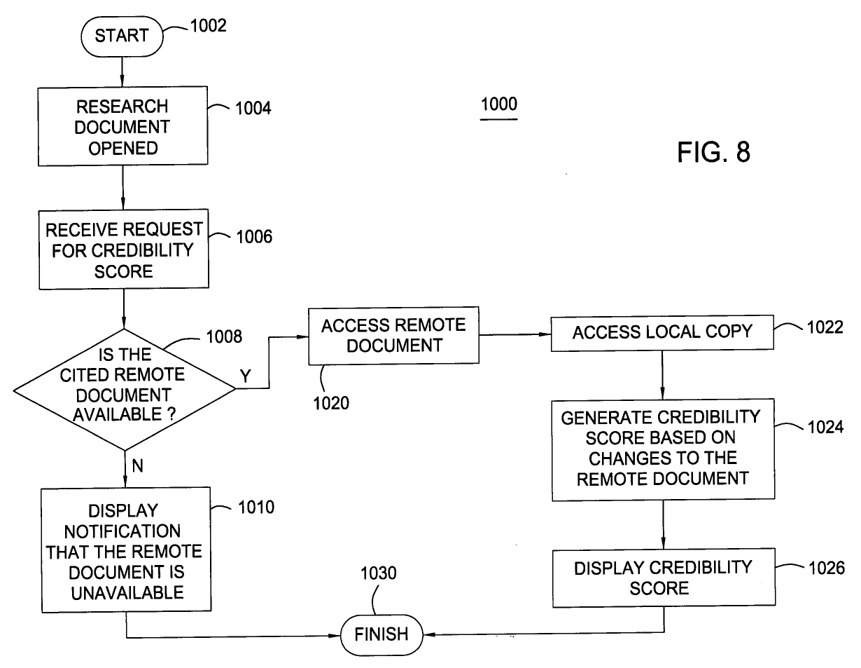

FIG. 8 is a flow diagram illustrating a process for displaying a credibility score for a cited document according to one embodiment of the invention. The process 1000 may begin at step 1002 and continue to step 1004 where the research document 130 is opened. According to one embodiment of the invention, a request for a credibility score may be received at step 1006. At step 1008 a determination may be made of whether the remote document 166 is available. If the remote document 166 is unavailable, a notification may be displayed at step 1010 which informs the user that the remote document 166 is unavailable and the process 1000 may then finish at step 1030. If, however, the remote document 166 is available, the remote document 166 may be accessed at step 1020. At step 1022 the local copy 140 of the remote document may be accessed, according to one embodiment of the invention. At step 1024 the credibility score for the remote document 166 may be calculated based on the changes that have occurred to the remote document 166 (as described above in greater detail). At step 1026, the calculated credibility score may be displayed. As described above, the credibility score may reflect the number of changes made to the remotely located document 166. Thus, a low credibility score may reflect many substantive changes to the remotely located document 166 and a higher credibility score may reflect fewer substantive changes to the remotely located document 166 or that the remotely located document 166 is unchanged. After the credibility score has been displayed at step 1026, the process may finish at step 1030.

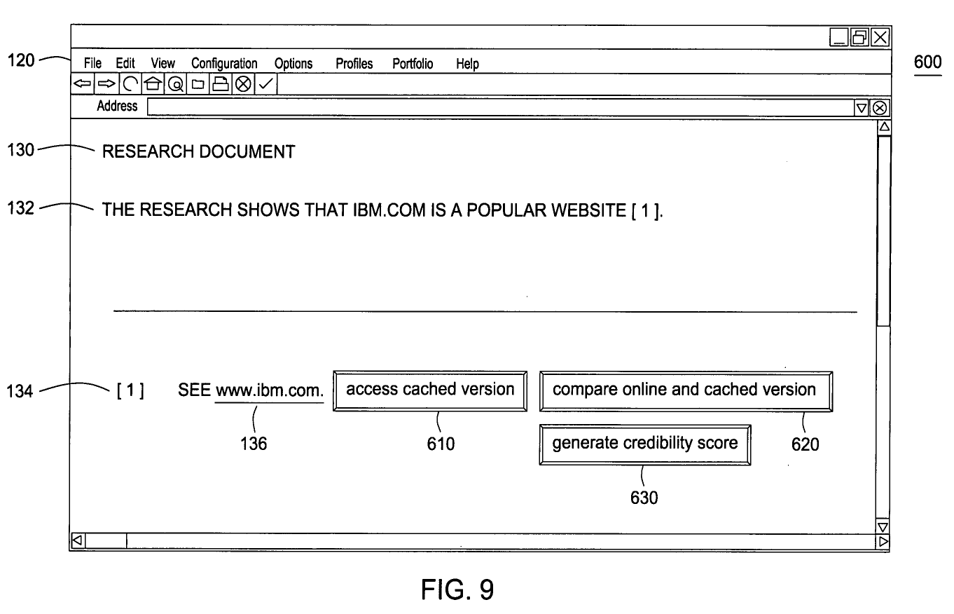

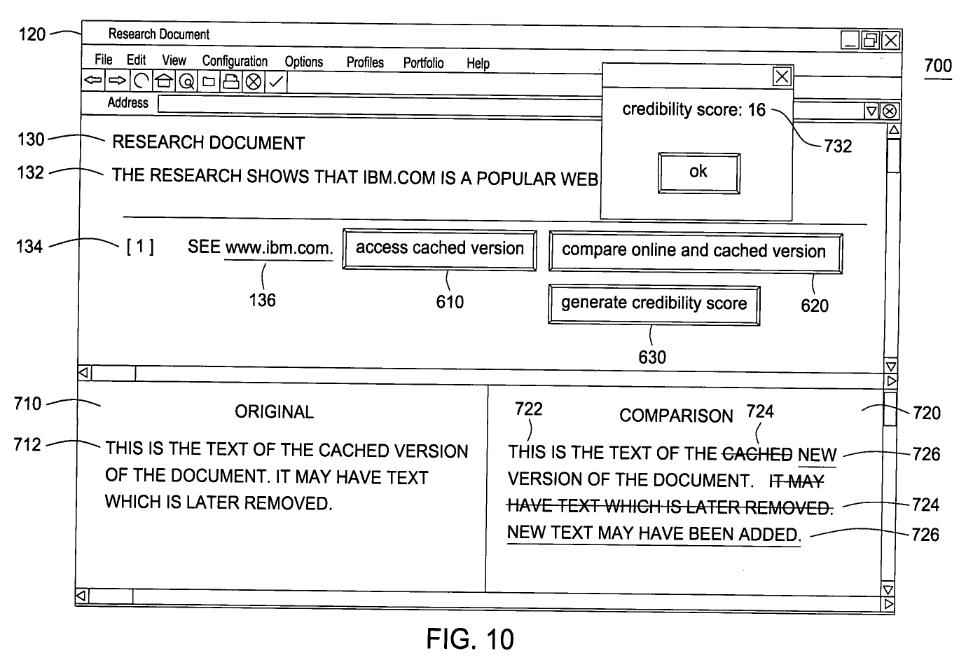

FIG. 9 is a diagram illustrating a graphical user interface 600 for displaying research documents containing one or more citations to remotely located documents according to one embodiment of the invention. Illustratively, the graphical user interface 600 is shown displaying the research document 130 containing the citation 134. The research document 130 may contain text 132 and the citation 134. The citation 134 may contain the link 136 to the remote document 166. By clicking the link 136, a network request may be sent to retrieve the remotely located electronic document 166. In the event that the remotely located document 166 cannot be accessed, the local copy 140 may be accessed using the association 138 between the research document 130 and the local copy 140. Alternatively, the user may explicitly request the local copy 140 by clicking a button 610 provided for that purpose. According to one embodiment, the graphical user interface 600 may contain a button 630 for generating a credibility score. In one embodiment, the graphical user interface 600 may also include a button 620 for comparing the remotely located document 166 and the local copy 140. For example, upon clicking the button 620, the user may be presented with the graphical user interface 700 depicted in FIG. 10.

FIG. 10 is a diagram illustrating a graphical user interface 700 for accessing and comparing an online 166 and cached version 140 of a remote document 166 according to one embodiment of the invention. When the user clicks the button 620 for comparing the online 166 and cached version 140 of the remote document 166, the word processor 120 may display two panes 710, 720. The first pane 710 may display the cached version 140 of the remote document 166 with the original text 712. The second pane 720 may display a view of the current version of the remote document 166 with a marked-up version of the current text 722. The marked-up text 722 may contain text which has been struck-through 724, showing where words were removed from the original text 712. The marked-up text 722 may also contain text which is underlined 726, showing where words were inserted into the original text 712. Thus, the user may be quickly informed by the user interface of exactly what changes have been made to the online version of the document 166 since it was downloaded 154 last. Also, upon clicking the button 630 for generating a credibility score, a pop-up dialog box 730 may be displayed to the user. The pop-up dialog box 730 may contain a message 732 indicating the credibility score for the new version of the remotely located research document 166. According to the exemplary Ul 700 depicted in FIG. 10, sixteen words may have changed from the original text 712 (seven added and nine removed). Thus, according to one embodiment of the invention, the credibility score may be calculated as sixteen.

While the foregoing is directed to embodiments of the present invention, other and further embodiments of the invention may be devised without departing from the basic scope thereof, and the scope thereof is determined by the claims that follow.

What is claimed is:

1. A method of preserving an association between electronic documents, comprising:
storing an electronic document at a storage media address, the electronic document containing a citation, the citation containing a link to a network address of a remotely located electronic document;
storing a copy of the remotely located electronic document;
associating the electronic document and the copy;
receiving a request for the remotely located electronic document;
attempting to access the remotely located electronic document; and
if the remotely located electronic document cannot be accessed, returning the copy of the remotely located electronic document.

2. The method of claim 1 wherein the copy is encrypted.

3. The method of claim 1, wherein the copy is stored in a single archiving document with the electronic document.

4. The method of claim 1, wherein the copy is stored at a storage media address and the association comprises a link in the electronic document to the storage media address of the copy.

5. The method of claim 1, wherein the association and the copy are preserved as long as the electronic document exists.

6. The method of claim 1, after storing a copy of the remotely located electronic document, further comprising:
specifying an event;
determining whether the event has occurred;
if so, determining whether the copy is different from the remotely located electronic document; and
if so, displaying a change notification.

7. The method of claim 6, wherein the change notification contains a comparison of the copy and the second copy.

8. The method of claim 6, wherein the event is an opening of the electronic document.

9. The method of claim 6, wherein the event is a periodically scheduled event.

10. The method of claim 1, wherein the electronic document is a research document.

11. The method of claim 1, wherein the association is created by an author of the electronic document.

12. A computer-readable medium containing a program which, when executed, performs an operation, comprising:
storing an electronic document at a storage media address, the electronic document containing a citation, the citation containing a link to a network address of a remotely located electronic document;
storing a copy of the remotely located electronic document;
associating the electronic document and the copy;
receiving a request for the remotely located electronic document;
attempting to access the remotely located electronic document; and
if the remotely located electronic document cannot be accessed, returning the copy of the remotely located electronic document.

13. The computer-readable medium of claim 12 wherein the copy is encrypted.

14. The computer-readable medium of claim 12, wherein the copy is stored in a single archiving document with the electronic document.

15. The computer-readable medium of claim 12, wherein the copy is stored at a storage media address and the association comprises a link in the electronic document to the storage media address of the copy.

16. The computer-readable medium of claim 12, after storing a copy of the remotely located electronic document, further comprising:
specifying an event;
determining whether the event has occurred;
if so, determining whether the copy is different from remotely located document; and
if so, displaying a change notification.

17. The computer-readable medium of claim 16, wherein the change notification contains a comparison of the copy and the second copy.

18. The computer-readable medium of claim 16, wherein the event is an opening of the electronic document.

19. The computer-readable medium of claim 16, wherein the event is a periodically scheduled event.

20. The computer-readable medium of claim 12, wherein the electronic document is a research document.

21. The computer-readable medium of claim 12, wherein the association is created by an author of the electronic document.

22. A system, comprising:
a processor;
a network connection device; and
a storage media containing a copy of an electronic document remotely located at a network address, a local electronic document which contains a pointer to the remotely located electronic document, the copy being associated with the local electronic document, and a program, the program when executed by the processor performing the steps comprising:
receiving a request for the remotely located electronic document;
determining whether the remotely located electronic document is unavailable or changed by querying the remotely located electronic document across the network connection device;
if the remotely located document is unavailable, returning the copy of the remotely located electronic document; and
if the remotely located electronic document is changed, displaying a change notification.

23. The system of claim 22 wherein the copy is encrypted.

24. The system of claim 22, wherein the copy is stored in a single archiving document with the local electronic document.

25. The system of claim 22, wherein the copy is stored at a storage media address and the association comprises a link in the electronic document to the storage media address of the copy.

26. The system of claim 22, wherein the change notification contains a comparison of the copy and the remotely located electronic document.

27. The system of claim 22, wherein the program determines if the remotely located electronic document is changed each time the local electronic document is opened.

28. The system of claim 22, wherein the program determines if the remotely located electronic document is changed on a periodic basis.

29. A method for displaying change notifications for a remotely located electronic document cited in an electronic document;
generating data corresponding to a first version of the remotely located electronic document;
storing the data corresponding to the first version of the remotely located electronic document;
specifying an event;
determining whether the event has occurred;
if so,
generating data corresponding to a second version of the remotely located electronic document;
determining whether the data corresponding to the first version of the remotely located electronic document is different from the data corresponding to the second version of the remotely located electronic document; and
if so, displaying a change notification.

30. The method of claim 29 wherein the electronic document is a research document.

31. The method of claim 29 wherein the event is an opening of the electronic document.

32. The method of claim 29 wherein the event is a periodically scheduled event.

33. The method of claim 29 wherein the data corresponding to the first version of the remotely located electronic document is a first hashcode and the data corresponding to the second version of the remotely located electronic document is a second hashcode.

34. The method of claim 29 further comprising:
comparing the first version of the remotely located electronic document to the second version of the remotely located document;
generating a value indicative of a difference between the first version of the remotely located document and the second version of the remotely located document; and
displaying the value indicative of the difference.
